(19) United States
(12) Patent Application Publication
(10) Pub. No.: US 2026/0316716 A1
(43) Pub. Date: Oct. 15, 2026

(54) ANTI-THEFT SYSTEM FOR A VEHICLE

(71) Applicant: IKS Technologies Inc., Varennes (CA)

(72) Inventors: Jean Poulin, Varennes (CA); Poulin Olivier, Saint-Basile-Le-Grand, (CA); Jérémy Poulin, Varennes (CA); Félix Poulin, Varennes (CA)

(21) Appl. No.: 19/485,392

(22) PCT Filed: Jun. 3, 2025
(86) PCT No.: PCT/CA2024/050742

§ 371 Date: Nov. 18, 2025

Related U.S. Application Data
(60) Provisional application No. 63/506,949, filed on Jun. 8, 2023.

(51) Int. Cl. B60R 25/045; B60R 25/10; B60R 25/102; B60R 25/104; B60R 25/23; B60R 25/32; B60R 25/33; B60R 25/40

(52) U.S. Cl. CPC B60R 25/045; B60R 25/1003; B60R 25/102; B60R 25/104; B60R 25/23; B60R 25/32; B60R 25/33; B60R 25/403

(57) ABSTRACT

An anti-theft system for a vehicle. The system includes a power source with positive terminal and negative terminals, an interrupt module, a decision module and an intelligent mobile application. A network interconnects the power source, the interrupt module, the decision module, and the intelligent mobile application. The network is configured so that in response to a signal wirelessly transmitted to the decision module from the intelligent mobile application a stop engine signal is transmitted to the interrupt module to stop an engine start sequence.

### TECHNICAL FIELD

The present generally concerns anti-theft systems and in particular an anti-theft system for a vehicle.

### BACKGROUND

Property theft remains a problem in today's society. In particular, theft of vehicles such as automobiles is an on-going concern. Despite improvements in elaborate anti-theft alarm systems, criminals who are intent on stealing automobiles are adept at cleverly overriding such alarm systems. Furthermore, tracking systems allow law-enforcement to locate stolen vehicles, but only after the vehicle has been stolen.

There is thus a clear need for an improved anti-theft system that prevent theft of personal property such as vehicles, and which is difficult to override.

### BRIEF SUMMARY

We have significantly reduced, or essentially eliminated, the problems associated with conventional anti-theft systems by designing a novel and unobvious anti-theft system that is useful for all types of vehicles. The system includes a kill switch that includes an interrupt module, a decision module, an alert (siren), and a so-called smart application. Advantageously, when connected, the modules communicate over a network to either disable the vehicle battery, thereby preventing an ignition sequence, or, if needed, trigger the alarm so as to alert the owner, on-lookers and the like, that a theft is in progress.

Accordingly, in one embodiment there is provided an anti-theft system for a vehicle, the system comprising:
a power source having a positive terminal and a negative terminal;
an interrupt module;
a decision module;
an intelligent mobile application;
a network interconnecting the power source, the interrupt module, the decision module, and the intelligent mobile application, the network being configured such that: i) in response to a first signal wirelessly transmitted to the decision module from the intelligent mobile application a stop engine signal is transmitted to the interrupt module to stop an engine start sequence.

In one example, the network interconnecting the power source, the power source, the interrupt module, the decision module, the intelligent mobile application, the network being configured such that ii) in response to a third signal wirelessly transmitted to the decision module from the intelligent mobile application, a start engine signal is transmitted to the interruption module to start the engine start sequence.

In one example, the stop engine signal stops the engine from being started by an unauthorized third party.

In one example, the start engine signal permits an authorized party to start the engine.

In one example, the intelligent mobile application is in wireless communication with the decision module, and configured to transmit start engine and stop engine signals to the decision module, the decision module being connected to the interrupt module to permit either starting the engine start sequence or prevent the engine stop sequence.

In one example, the intelligent mobile application is located on a handheld mobile electronic device. The handheld mobile electronic device is a smartphone or a tablet.

In one example, the power source is a 12-volt battery. A power circuit includes the interrupt module connected to the positive battery terminal to open or close a vehicle power circuit during the engine start or engine stop sequence. The decision module is connected to the interrupt module, the decision module controlling the opening and closing of the vehicle power circuit. The interrupter module includes a clamping member connected to the positive terminal; a gate to open or close the battery power circuit and a connector member for inserting the original battery power cable into the interrupter module. The clamping member includes two clamping screws that permit jaws to clamp onto the positive terminal. The gate includes a moveable plunger to move forward or backward to close the power circuit or to open the power circuit depending on the signal received at the decision module. The moveable plunger is a gear system activated by a piston or a worm screw with a rotating motor, or a piston for pushing the plunger to maintain the closed position until the decision module signals to move the plunger back. A positive power cable from the battery to be inserted into the clamping member and the clamping being carried out by the clamping screws. In another example, the interrupt module and the decision module are located in a housing, the decision module being operable using a phone card, Bluetooth, or a 10-digit keypad accessible from exterior the housing. The decision module is further operable using an accelerometer, or a geographic positioning system. The phone card receives the confirmation or not of the activation of the interruption module so as to authenticate the driver, the engine being stopped if the decision module does not receive a signal to send a signal to the interrupt module. The Bluetooth™ has a range of 3 meters, which allows the first contact with the user of the vehicle, a text message confirms that the user wishes to start the vehicle, the vehicle that receives the second confirmation of acceptance from the user can start the vehicle. The 10-digit keypad on the decision module housing, allows the lock command to be sent to the interrupt module with an 8-digit security code. The accelerometer that allows the user to check if the vehicle is moving forward, backward or stationary. The geographic positioning which allows location of the vehicle and to send a geographic positioning if a theft by towing attempt is in progress.

In another example, the system further includes an alarm mounted in the vehicle engine. The alarm is a siren having a sound level of up to 130 decibels.

Accordingly, in another embodiment, there is provided a circuit comprising:
a power source having a positive terminal and a negative terminal;
an interrupt module;
a decision module;
an intelligent mobile application;
a network interconnecting the power source, the interrupt module, the decision module, and the intelligent mobile application, the network being configured such that: i)in response to a first signal wirelessly transmitted to the decision module from the intelligent mobile application a stop engine signal is transmitted to the interrupt module to stop an engine start sequence.

Accordingly, in another embodiment, there is provided an intelligent kill switch system for a vehicle, the system comprising:
a power source;
an interrupt module;
a decision module;
a siren;
an intelligent mobile application;
a network interconnecting the power source, the interrupt module, the decision module, the siren and the intelligent mobile application, the network being configured such that:
i) in response to a first signal wirelessly transmitted to the decision module from the intelligent mobile application a stop engine signal is transmitted to the interrupt module to stop an engine start sequence

In one example, the network interconnecting the power source, the power source, the interrupt module, the decision module, the intelligent mobile application, the network being configured such that:
i) in response to a third signal wirelessly transmitted to the decision module from the intelligent mobile application, a start engine signal is transmitted to the interruption module to start the engine start sequence.

In another example, the interrupt module includes a relay and an accelerometer, the accelerometer being configured to detect varying frequency motion and towing attempts by increasing the reference angle of the accelerometer.

In another example, the interrupt module includes a relay that is normally open or closed in the case of a direct battery connection, and an accelerometer that detects both low-and high-frequency motion and towing attempts by increasing the reference angle of the accelerometer.

In another example, the decision module is includes a phone card, a Bluetooth™, an internal battery, an accelerometer, and a geographic positioning system, each configured to signal the interruption module. The telephone card confirms whether or not the interruption module has been activated. The Bluetooth™ connects to the decision module at first contact with the vehicle user, the drive receiving a plurality of text messages. The accelerometer verified if the vehicle is moving forwards, backwards or stationary, the vehicle fails to obtain double confirmation and moves forwards or backwards, or changes angle according to the departure axes of the two accelerometers, the decision module sends a notification of attempted theft and power the siren as an audible warning. The geographic positioning permits location of the vehicle and transmission of a geographic positioning signal if a theft attempt by towing is in progress The siren has a sound level of 130 decibels.

In yet another example, an external numeric keypad is used only when a cellular network is unavailable, or the smartphone has no battery power, a unique 4-digit code being sent to confirm vehicle selection.

In yet another example, the system is a vehicle anti=theft system.

### BRIEF DESCRIPTION OF THE DRAWINGS

These and other features of that described herein will become more apparent from the following description in which reference is made to the appended drawings wherein:

FIG. 1 is a schematic representation of an anti-theft system network;

FIG. 1A is perspective view of an anti-theft system connected to a vehicle battery showing a decision module security code box;

FIG. 2 is a perspective view of a housing having therein a kill switch;

FIG. 3 is a perspective view of a decision module showing a security code;

FIG. 4 is a circuit board showing a SIM card and a geographical positioning system located in the decision module;

FIG. 5 is a circuit board showing an internal battery, a computing system and an accelerometer located in the decision module;

FIG. 6 is a representative schematic diagram of an intelligent kill switch located in a circuit with a vehicle starter

FIG. 7 is a representative schematic diagram of the intelligent kill switch located in a circuit with a vehicle battery;

FIG. 8 is a representative schematic diagram of the intelligent kill switch located in a circuit with an electronic control module; and

FIG. 9 is an aerial photographic view of a geofence for the intelligent kill switch.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

Broadly speaking, we have designed an anti-theft system for all types of vehicles, including petrol-driven vehicles or electric-driven vehicle, which makes vehicle theft virtually impossible. An Intelligent Kill Switch (IKS) features an interrupt module, a decision module, a siren and a smart/intelligent mobile application (also referred to as an “app”) for Android™ and Apple™. The interrupt module can be installed either on the vehicle's starter motor or on the positive terminal of the vehicle's battery. In both cases, the interrupt module (IKS-NO) is installed in the engine compartment and opens or closes the starter or battery power circuit. The decision module, also in the vehicle engine compartment, is connected to the interrupt module and controls the actions to be taken to open or close the battery's positive terminal circuit. The actions that the decision module activates come from the intelligent mobile application that sends the necessary authorizations so that the decision module can send confirmation of whether to close the interrupt module. This permits the vehicle owner to remotely start the engine or prevent it from being started by an unauthorized third party who does not have the rights to the vehicle.

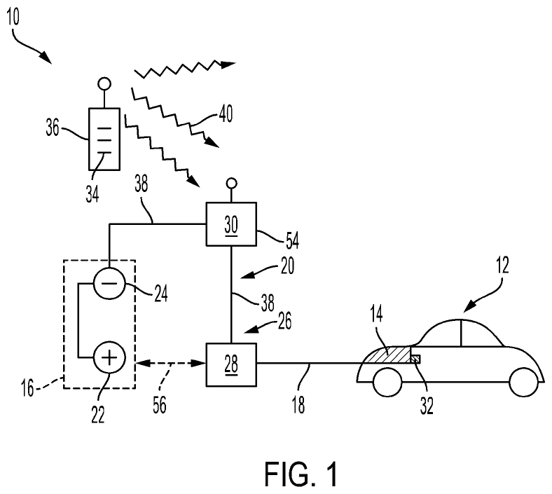

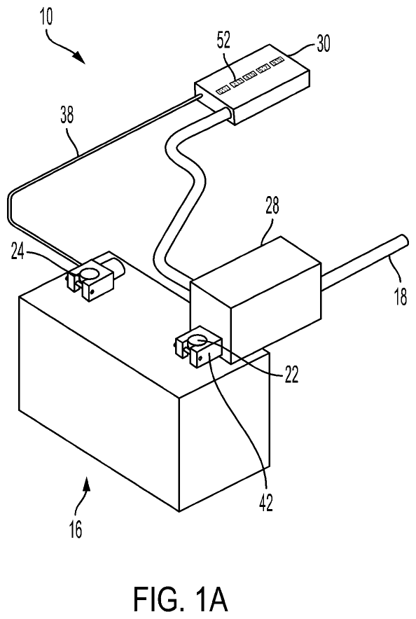

Referring now to FIG. 1, and FIG. 1A, there is illustrated generally at 10 an anti-theft system useful to prevent unauthorized movement and use of a vehicle 12. In one example, the vehicle 12 is an automobile, although it should be understood that the anti-theft system 10 can be used on any type of vehicle. The anti-theft system 10 is mounted on a vehicle engine 14 in the engine compartment, and is connected to a battery power source 16. Typically, one or more anchors 18 are used to secure the anti-theft system 10 to the engine 14. The battery 16 is typically in the form of a 12-volt battery, which is standard for many vehicles and is part of a vehicle power circuit 20, which operates the ignition system of the vehicle 12. The battery 16 includes a positive terminal 22 and a negative terminal 24. Advantageously, the system 10 is designed to make it virtually impossible to steal the vehicle 12.

Still referring to FIG. 1 and FIG. 1A, the system 10 includes an intelligent anti-theft kill switch 26 which includes an interrupt module 28, a decision module 30, a siren 32 and a smart application 34 installed on a hand-held mobile electronic device 36 such as a smartphone or a tablet. Examples of operating system used on the electronic device include, for example, Android™ and Apple Computing IOS™. The interrupt module 28 is connected directly on the positive battery terminal 22 in the engine compartment. The interrupt module 28 is used to open or close the vehicle power circuit 20. The decision module 30, which is also in the engine compartment, is electrically connected to the interrupt module 28. The decision module 30 is the component that controls the actions that permit opening and closing of the power circuit 20 specially at the positive battery terminal 22. A plurality of wires 38 electrically interconnect components of the system 10, thereby defining a network, which is remotely controlled by the smart application 34 As best illustrated in FIG. 1, an activation decision signal 40 is transmitted wirelessly to activate the decision module 30. The activation signal 40 sends the necessary authorizations to the decision module 30 so as to confirm whether or not the interruption module 28 can open or close the power circuit 20 at the positive terminal 22. The allows the vehicle owner (not shown) to be able to start the vehicle engine or to prevent an unauthorized third party from starting the vehicle 12 and therefore potentially stealing it.

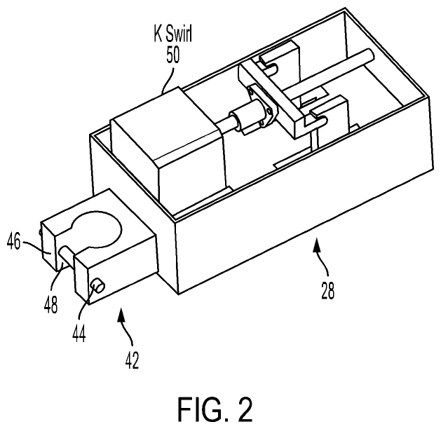

As best seen in FIGS. 1A and 2, the interrupter module 28 includes a clamping mechanism 42 at the positive battery terminal 22 and a kill switch 50. The clamping mechanism 42 couples to the positive terminal 22 of the battery 16 and has two clamping screws 44, 46 that allow jaws 48 to clamp onto the positive terminal 22. This secures the interrupter module 28 so that vibration does not affect the operation of the circuit. The kill switch 50 includes an actuator mechanism that allows a plunger 56 to move forward or backward to close the power circuit 20 or to open it according to the command of the decision module 30 that is received thereto. In one example, a gear system is activated by a piston or a worm screw with a rotating motor, or a piston that pushes the plunger and keeps it in the closed position until the decision module 30 sends a new command signal to move the plunger back. The kill switch 50 also allows the positive power cable from the battery 16 to be inserted into the clamping mechanism 42 of the switch module 50 and the clamping is carried out using the two clamping screws 44, 46. In addition, this section allows the addition of three extra wires for additional components or products other than our system.

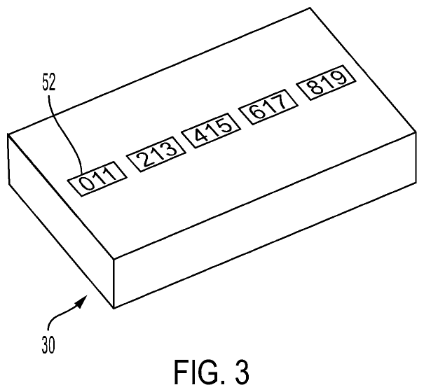

Referring no to FIGS. 1, 1A and 3, the decision module 30 includes a phone card a Bluetooth™, which permits remote signal transmission/receipt when paired with the hand-held mobile electronic device 36, and a 10-digit keypad 52 accessible from outside decision module housing 54.

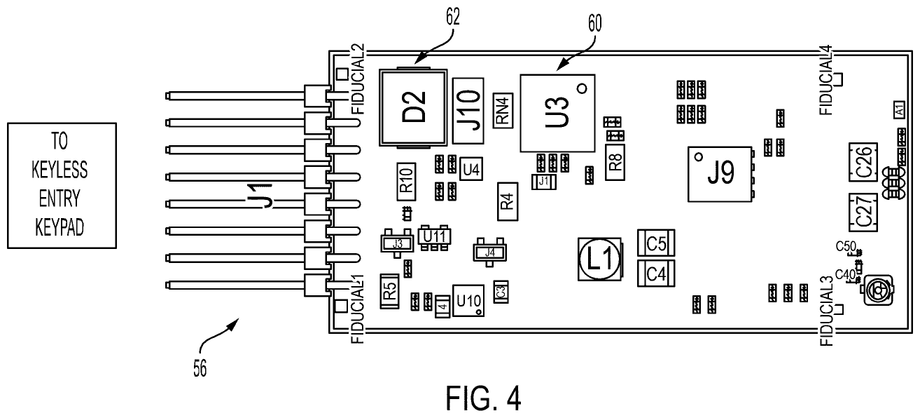

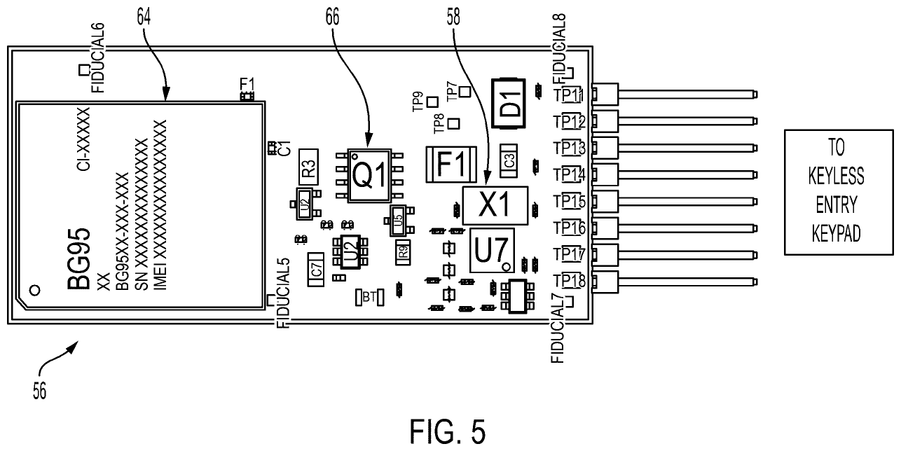

Referring now to FIGS. 4 and 5, there is illustrated a circuit board 56 having an accelerometer 58 and a geographic positioning system 60. Also included on the circuit board 56 are a SIM card 62, a battery 64, and a computer 66. Each of these features has a specific characteristic that permits the decision module 30 to send the correct signal to the interruption module 28, thereby eliminating the risk of vehicle theft.

More specifically, the phone card (not shown) allows to the system to receive confirmation or not of the activation of the interruption module 28. This functionality provides the proper functioning of the system and allows authentication of the driver (typically the owner of the vehicle) according to two verification methods. If the two methods fail to match, the decision module 30 will not send a positive signal to the interrupt module 28.

The Bluetooth™ with a range of 3 meters, allows a first contact with the user (the driver and/or owner) of the vehicle. When the user approaches the vehicle 12 a text message confirms that the user wishes to start the vehicle 12 is sent to the user via the user's smartphone 36. This allows the user to confirm that they wish to start the vehicle 12. A driver (user) can receive several text messages because they can be connected on several Bluetooth™ devices in a fleet of vehicles of, for example, a business, or family members. Thus, only the vehicle 12 that receives a second confirmation of acceptance from the driver will be able to start the vehicle 12.

The 10-digit keypad on the decision module housing 52, which allows a lock command to be sent to the interrupt module 28 using an 8-digit security code. Therefore, if the driver is in an area where there is no cellular network, the driver will be able to dial a personalized 8-digit security code and activate the interrupt module 28. The 8-digit security code cannot contain a sequential number sequence of more than three digits, such as 1234, and a number sequence cannot occur more than once in the 8-digit code, so a code such as 12356123 or 12121212 cannot be saved as an 8-digit security code because 123 occurs twice and 12 occurs more than 4 times. Also, this logic applies to identical numbers such as 11111111. When the user confirms the security code, the software application 34 on the smartphone 36 will check the conformity of the security code.

The accelerometer 58 allows the user to check if the vehicle 12 is moving forward, backward or is stationary. This feature ensures that the interrupt module 28 will not receive any confirmation to open the power circuit 20 when the vehicle 12 is moving forward or backward after receiving double confirmation from the driver. In addition, if the vehicle has not received a double confirmation and is moving forward or backward, the decision module 30 will send a text message of an attempted tow theft and will power an alert siren 32 as an audible warning. The siren 32 is installed in the engine compartment to signal an attempted tow-away. The siren has a sound level of 130 decibels.

Finally, the geographic positioning 60 permits location of the vehicle 12 and sends a geographic positioning if a theft by towing attempt is in progress.

Generally speaking, the mobile application 34 is either Android™ or iPhone™ and allows the user to quickly connect via Bluetooth™ to the decision module 30 to activate the interruption module 30 and close the circuit 20 using the plunger 56. The application on the smartphone allows the user to pair up on several vehicles and to have a prioritization list that allows to quickly connect to the desired vehicle 12. When the driver wants to take a vehicle on a priority list, he must first activate the application via a widget on his phone to activate Bluetooth™ connectivity and receive a text message from each of the vehicles on the priority list and he then chooses the vehicle he wants to pair up with.

### Alternative Embodiments

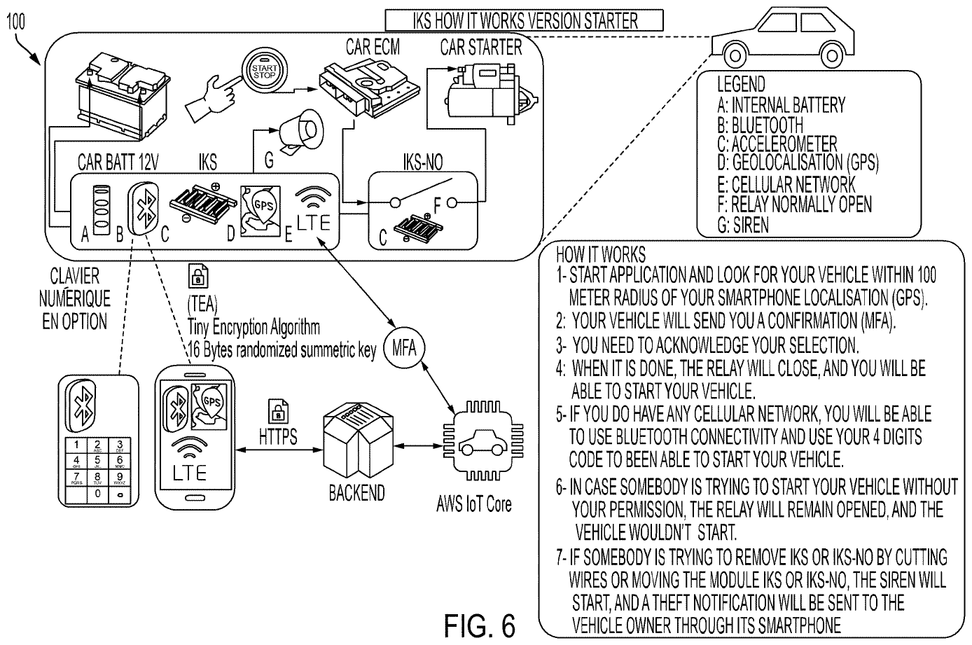

Referring now to FIGS. 6 to 8, an alternative circuit 100 includes an interrupt module 102 that includes two electronic components, namely a relay that is typically in an open or closed configuration, in the case of a direct battery connection, and an accelerometer that detects both low-and high-frequency motion and an unauthorized movements such as, for example, towing attempts by increasing the reference angle of the accelerometer. A decision module includes five features specific to the decision module. The first feature is a phone card, the second feature is Bluetooth™, the third feature is an internal battery, the fourth feature is an accelerometer, and the fifth feature is a geographic positioning system (GPS). Each of these features has a specific characteristic that enables the decision module to send the right signal to the interruption module, thus eliminating the risk of vehicle theft. The telephone card, which is used to receive confirmation of whether or not the interruption module has been activated. This feature to the correct operation of the product and enables the driver to be authenticated using two verification methods. If the two methods do not match, the decision module will not send a positive signal to the interrupt module. The Bluetooth™, has an operational range of about 3 meters, which allows the user to connect to the decision module at first contact with the vehicle user. The user, when approaching the vehicle receives a text message confirming that the user wishes to start the vehicle. The text message is sent/received via a handheld electronic device such as a smartphone, and confirms that the user indeed wishes to start the vehicle. A driver can receive a plurality of text messages, because they may be wirelessly connected to several Bluetooth™ devices in a fleet of company or family vehicles. Advantageously, only the vehicle that receives the second confirmation of acceptance from the driver will be able to start it. The internal battery that maintains the decision module and the interrupt module in, on one example, a powered mode for about three to four hours without being connected to the vehicle's main battery supply. Person skilled in the art will readily recognize that the powered mode may increase or decrease depending on the capacity of the internal battery. The accelerometer verifies whether the vehicle is moving forwards, backwards or is stationary. This ensures that the interrupt module receives no confirmation to open the power circuit when the vehicle is moving forwards or backwards, after double confirmation from the driver. In addition, the accelerometer detects low or high vibration frequencies and cross-checks with the interrupt module's accelerometer the type of action the vehicle is undergoing. If the vehicle fails to obtain double confirmation and moves forwards or backwards, or changes angle according to the departure axes of the two accelerometers, the decision module will send a notification of attempted theft and power the siren as an audible warning. The geographic positioning aspect allows the user to locate the vehicle and send a geographic positioning signal if a theft attempt by towing is in progress.

A siren is installed in the engine compartment to warn of attempted theft if a wire is cut or torn, or the vehicle is being towed. In one example, the siren has a sound level of 130 decibels.

An external numeric keypad is used only when no cellular network available to the user, and if the smartphone has no battery power and thus cannot use the internal Bluetooth™. In this case, the external keypad is necessary as a failsafe, and the driver must send his 4-digit code to confirm the vehicle's selection.

The mobile application for Android™ or iPhone™ allows the user to rapidly log in via the Cloud and multi factor authentication (MFA) and requires the driver to identify himself using the smartphone or artificial intelligence. Thus, if the user fails to identify themselves to the vehicle that is require for use, the internal kill switch technology will not allow the vehicle to start and will send an attempted theft notification to the owner of the vehicle that the individual is trying to start, even if they have obtained a “door unlock” code.

A number of additional app functionalities enable maximum connection security between the cloud platform and the decision module. Wireless communication via Bluetooth™ can communicate with the decision module if the application fails to access the cellular network. In this case, the app will use Bluetooth™ functionality to connect with the decision module and thereby confirms the driver identity by sending a 4-digit one-time code (known as a “Rolling Code”) to the decision module, enabling the driver to start the vehicle's engine.

By using a combination of features such as normally open or closed relay, the accelerometer calculation algorithms, Bluetooth™, smart phone, dual authentication, the mobile app, the internal battery, the external keypad, and an “attempted theft notification” sent to the vehicle owner, the user may advantageously stop attempted vehicle theft and allow greater control over the vehicle(s) the owner owns.

Referring now specifically to FIG. 6, for vehicles that have internal combustion engines, and are petrol/gasoline driven the engine includes a starter motor, which needs temporary assistance to start. In the system that is installed on the starter motor, and with the cloud-based components and structures we use, the system provides absolute control over the starting of the vehicle fitted with it. To do this, the circuit includes the interrupt module IKS-NO is connected, in series, with the starter control wire coming directly from the vehicle's ECM to enable the ECM to send the vehicle's start signal. In addition, the IKS module is installed in the engine compartment to enable it to be powered by the vehicle's battery. The 130-decibel siren is connected to the circuit in series.

In the IKS-NO module, which is connected in series to the starter wire, two electronic components: a relay which is normally open, and an accelerometer which enables us to detect any movement not attributed to normal vehicle operation. In addition, this module is connected to the IKS module, which sends it the command to close or not the relay, enabling the owner to start the vehicle.

Inside the IKS module, five electronic components allow the user engage the anti-theft system for internal combustion vehicles. These five components include an internal battery, a Bluetooth™ module, an accelerometer, a GPS module and an LTE cellular network module. Each of these components plays a defined role in controlling the opening or closing of the IKS-NO module.

The IKS operation is as follows. The mobile application, which is compatible with Android and iPhone platforms, enables the user to communicate with the IKS module via the user's cloud infrastructure, and to receive confirmation from the IKS module that the user wishes to use this vehicle.

When the vehicle is needed to start, user opens the application, which will search for all the IKSs that are locally available and to which the user has access within a radius of about 100 meters, and display on the application those vehicles that are available. This search is carried out via a proprietary cloud-based database, and when it's complete, the user selects the required vehicle and sends confirmation to the chosen IKS, which then sends the command to the IKS-NO to close the relay and leave the vehicle owner free to start the vehicle.

If the IKS fails to receive confirmation that the owner wants to use it, the relay in the IKS-NO will remain open and the vehicle will not start. The system detects several infringements, such as starting the vehicle without double confirmation. In this case, even if the user has the vehicle's original key, but has failed to carry out the double confirmation process, the vehicle will not start, and “an attempted theft notification” will be sent to the vehicle owner. If a third party tries to remove power from the IKS module, either by disconnecting a power wire from the vehicle battery or from the module, the internal battery will take over and continue powering the components to maintain system integrity, and an attempted theft notification will be sent to the vehicle owner. If a third party tries to touch the IKS module when the vehicle is stationary, the accelerometer will detect the unusual movement and the IKS-NO module relay will remain closed. A theft notification will automatically be sent to the vehicle owner. If a third party tries to bypass the IKS-NO using external wires, the IKS-NO will detect this, and a theft notification will be sent to the vehicle owner. If a third party tries to remove the IKS-NO from the vehicle, the internal accelerometer will detect this and the relay will remain open to prevent theft of the vehicle, and a theft notification will be sent to the owner.

In addition, the use of two accelerometers enables the user to detect any unusual ambient noise around the vehicle, such as violent shocks, shearing of pipes, installation of unwanted parts on the vehicle or towing of the vehicle, and the like. In all such cases, the owner will be notified of the event.

If a cellular network is unavailable, in the case where the vehicle is parked in an underground lot, the user uses the application with the BluetoothTM connection and a unique code (Rolling code) to confirm that the user wishes to use the vehicle. Furthermore, if a cellular network is unavailable and there is no battery power in the smartphone, the user can confirm the code with an external numeric keypad.

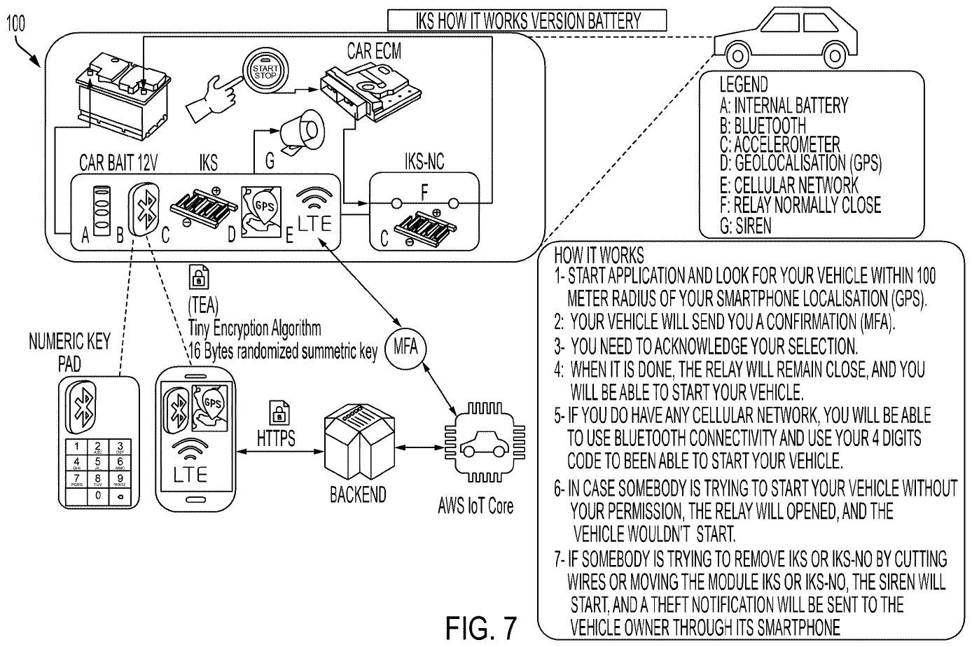

Referring now to FIG. 7, for an electric vehicle the system connects directly to the 12-volt battery that powers all the vehicle's electronic components. In this case, the system is installed on the battery's positive circuit, and with all the cloud components and structures we use, we can provide absolute control over the starting of the vehicle equipped with it. To do this, the IKS-NO must be connected in series with the battery's positive wire to control the power supply to the electronic components. In addition, we install the IKS module in the engine compartment to enable it to be powered by the vehicle's battery and a 130-decibel siren.

In the IKS-NO module, which is connected in series to the battery's positive lead, we have two electronic components: a relay which is normally closed, and an accelerometer which enables us to detect any movement not attributed to normal vehicle operation. In addition, this module is connected to the IKS module, which sends it the command to open the relay or not, enabling the owner to start the vehicle. Inside the IKS module, the five electronic components enable the user to perform the task as an anti-theft system for internal combustion vehicles. These five components include an internal battery, a Bluetooth™ module, an accelerometer, a GPS module, and an LTE cellular network module. Each of these components plays a defined role in controlling the opening or closing of the IKS-NO module.

The operation of the IKS system uses the mobile application, which is compatible with Android™ and iPhone™, and enables the user to communicate with the IKS module via the proprietary cloud infrastructure, and to receive confirmation from the IKS module that the user wants to use this vehicle.

So, when the user want to start a vehicle, the user opens the application and it will search for all the IKS that are available and to which the has access within a radius of about 100 meters, and display on the application those that are available. This search is carried out via the cloud-based database, and when it's complete, the user selects the desired vehicle and sends confirmation to the chosen IKS so that it can send a command to the IKS-NO to keep the relay closed, leaving the vehicle owner free to start the vehicle.

If the IKS does not receive confirmation that the owner wants to use it, the relay in the IKS-NO will open and the vehicle will not start. The system detects several infringements, such as starting the vehicle without double confirmation. In this case, even if the user has the vehicle's original key but has not carried out the double confirmation process, the vehicle will not start, and an attempted theft notification will be sent to the vehicle owner. If a third party tries to remove power from the IKS module, either by disconnecting a power wire from the vehicle battery or from the module, the internal battery will take over and continue powering the components to maintain system integrity, and an attempted theft notification will be sent to the vehicle owner. If a third party tries to touch the IKS module when it's stationary, the accelerometer will detect the unusual movement and the IKS-NO module relay will open. A theft notification is automatically sent to the vehicle owner. If a third party tries to bypass the IKS-NO using external wires, the IKS-NO will detect this and a theft notification will be sent to the vehicle owner. If a third party tries to remove the IKS-NO from the vehicle, the internal accelerometer will detect this and the relay will open to prevent theft of the vehicle, and a theft notification will be sent to the owner.

What's more, the use of both accelerometers enables the user to detect any unusual ambient noise around the vehicle, such as violent shocks, shearing of pipes, installation of unwanted parts on the vehicle and towing of the vehicle. In all these cases, the owner will be notified of the event.

If no cellular network available, because the vehicle is parked underground, the user can use the application with the Bluetooth™ connection and a unique code (Rolling code) to confirm that we want to use the vehicle.

If a cellular network unavailable and no battery power is available in the smartphone, the user can confirm the code with an external numeric keypad.

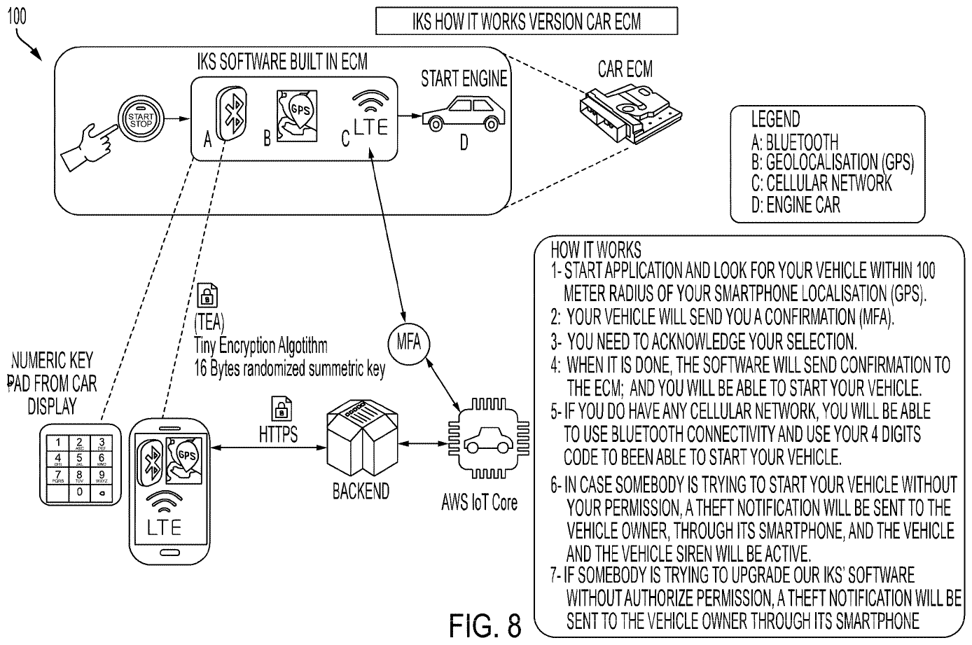

Referring now to FIG. 8, in which an electronic control module (ECM) is used, the system controls the vehicle's internal functionality and the user no longer needs to install the two external modules, because the user, advantageously can control the vehicle's start-up functionality from within the vehicle's control software.

Operation of the IKS system is very simple, because the mobile application, which is compatible with Android™ and iPhone™, enables the to communicate directly with the vehicle's communication system via the cloud proprietary infrastructure, and to receive confirmation from the vehicle via the IKS software that the user wishes to use that vehicle.

So, when the wants to start a vehicle, the user, as described above, opens the application and it will search for all the IKS that are available and to which the user has access within a radius of about 100 meters, and display on the application those that are available. This search is done through the cloud database, and when it's complete, the user selects the desired vehicle and sends confirmation to the chosen IKS to allow the vehicle to start.

If the IKS doesn't receive confirmation that the owner wants to use it, the IKS won't allow the vehicle to start. In this case, even if the user has the vehicle's original key but have not performed the double confirmation process, the vehicle will not start, and an attempted theft notification will be sent to the vehicle owner.

If there is no cellular network available, because the vehicle is parked in an underground lot, the user can use the application with the Bluetooth™ connection and a unique code (Rolling code) to confirm that the user wants to use the vehicle. If there is no available cellular network and no battery power in the smartphone, the user can confirm the code with an external numeric keypad.

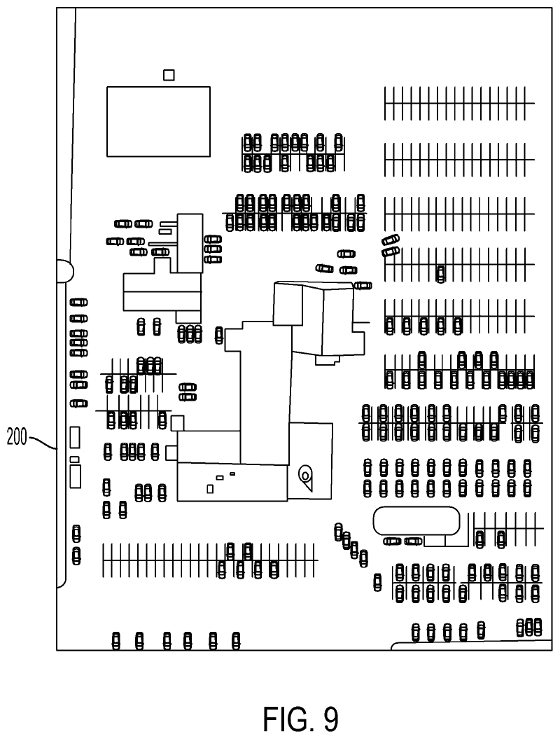

Referring now to FIG. 9, another aspect of the system includes the ability to create virtual barriers to control theft attempts in large-scale outdoor car parks. If the vehicle is equipped with the system, the application can locate the IKS inside this virtual barrier and protect the vehicle even if it has not yet been configured. Furthermore, the system allows the use of vehicles in a time slot predetermined by the parking lot owner. This means that the owner could use the vehicle from, for example, 8 a.m. to 5 p.m., and the IKS system would automatically protect the vehicle from theft after this time. A white rectangle 200 defines the virtual barrier where all vehicles equipped with the IKS product will be automatically protected outside the time slot defined by the owner of the parking area.

Additionally, the IKS product allows the user to add skill levels according to the types of driving classes that are permitted in the country where the IKS is installed. This means that IKS must determine whether the driver has the right class of driving license. In addition, special skills can be added to this license class, such as skills for driving hazardous materials, skills for driving off-road vehicles such as excavators, hydraulic shovels and so on. Example of license class (1, 2, 3, 4A, 4B, 5, 6A, 6B, 6C, 6D, 6E, 8) that must be added to the driver to be associated with the right vehicle for the license class and skills.

### Other Embodiments

From the foregoing description, it will be apparent to one of ordinary skill in the art that variations and modifications may be made to the embodiments described herein to adapt it to various usages and conditions.

1. An anti-theft system for a vehicle, the system comprising:
a power source having a positive terminal and a negative terminal;
an interrupt module;
a decision module;
an intelligent mobile application;
a network interconnecting the power source, the interrupt module, the decision module, and the intelligent mobile application, the network being configured such that:
i) in response to a first signal wirelessly transmitted to the decision module from the intelligent mobile application a stop engine signal is transmitted to the interrupt module to stop an engine start sequence.

2. The system, according to claim 1, in which the network interconnecting the power source, the power source, the interrupt module, the decision module, the intelligent mobile application, the network being configured such that:
ii) in response to a third signal wirelessly transmitted to the decision module from the intelligent mobile application, a start engine signal is transmitted to the interruption module to start the engine start sequence.

3. The system, according to claim 2, in which the stop engine signal stops the engine from being started by an unauthorized third party.

4. The system, according to claim 2, in which the start engine signal permits an authorized party to start the engine.

5. The system, according to claim 1, in which the intelligent mobile application is in wireless communication with the decision module, and configured to transmit start engine and stop engine signals to the decision module, the decision module being connected to the interrupt module to permit either starting the engine start sequence or prevent the engine stop sequence.

6. The system, according to claim 1, in which the intelligent mobile application is located on a handheld mobile electronic device.

7. The system, according to claim 6, in which the handheld mobile electronic device is a smartphone or a tablet.

8. The system, according to claim 1, in which the power source is a 12-volt battery.

9. The system, according to claim 8, in which a power circuit includes the interrupt module connected to the positive battery terminal to open or close a vehicle power circuit during the engine start or engine stop sequence.

10. The system, according to claim 9, in which the decision module is connected to the interrupt module, the decision module controlling the opening and closing of the vehicle power circuit.

11. The system, according to claim 9, in which the interrupter module includes a clamping member connected to the positive terminal; a gate to open or close the battery power circuit and a connector member for inserting the original battery power cable into the interrupter module.

12. The system, according to claim 11, in which the clamping member includes two clamping screws that permit jaws to clamp onto the positive terminal.

13. The system, according to claim 11, in which the gate includes a moveable plunger to move forward or backward to close the power circuit or to open the power circuit depending on the signal received at the decision module.

14. The system, according to claim 13, in which the moveable plunger is a gear system activated by a piston or a worm screw with a rotating motor, or a piston for pushing the plunger to maintain the closed position until the decision module signals to move the plunger back.

15. The system, according to claim 12, in which a positive power cable from the battery to be inserted into the clamping member and the clamping being carried out by the clamping screws.

16. The system, according to claim 1, in which the interrupt module and the decision module are located in a housing, the decision module being operable using a phone card, Bluetooth, or a 10-digit keypad accessible from exterior the housing.

17. The system, according to claim 16, in which the decision module is further operable using an accelerometer, or a geographic positioning system.

18. The system, according to claim 16, in which the phone card receives the confirmation or not of the activation of the interruption module so as to authenticate the driver, the engine being stopped if the decision module does not receive a signal to send a signal to the interrupt module.

19. The system, according to claim 16, in which the Bluetooth has a range of 3 meters, which allows the first contact with the user of the vehicle, a text message confirms that the user wishes to start the vehicle, the vehicle that receives the second confirmation of acceptance from the user can start the vehicle.

20. The system, according to claim 16, in which the 10-digit keypad on the decision module housing, allows the lock command to be sent to the interrupt module with an 8-digit security code.

21. The system, according to claim 16, in which the accelerometer that allows the user to check if the vehicle is moving forward, backward or stationary.

22. The system, according to claim 16, in which the geographic positioning which allows location of the vehicle and to send a geographic positioning if a theft by towing attempt is in progress.

23. The system, according to claim 1, further includes an alarm mounted in the vehicle engine.

24. The system, according to claim 23, in which the alarm is a siren having a sound level of up to 130 decibels.

25.-37. (canceled)
